(19) United States
(12) Patent Application Publication
(10) Pub. No.: US 2006/0151420 A1
(43) Pub. Date: Jul. 13, 2006

(54) Nipple adapter for a bottle comprising a screw neck

(76) Inventor: Mark Dorton Espenschied, Aliso Viejo, CA (US)

Correspondence Address: Mark Dorton Espenschied, 27662 Aliso Creek Rd, Apt 2113, Aliso Viejo, CA, 92656, US

(21) Appl. No.: 10/661,934

(22) Filed: Sep. 15, 2003

(51) Int. Cl. B65D 45/30; A61J 11/00; A61J 9/08

(52) U.S. Cl. 215/276; 215/11.6; 215/11.1

(57) ABSTRACT

A nipple end-piece adapter is disclosed for a bottle having a threaded neck, and further comprising an inner threaded chimney on one end of the adapter, adapted for cooperating with the thread of the neck of the bottle, a sidewall on the other end of the adapter also threaded for receiving the ring of the end-piece and, in addition, a skirt connected to the chimney, shaped and positioned so that it cooperates sealingly with the internal face of the neck of the bottle when the adapter is fixed thereon by screwing its chimney on the neck. The adapter is configured to act as an extension of the bottle neck, thereby creating a neck which an infant or toddler can easily grasp, and making it accessible for a caregiver to disassemble for cleaning.

### RELATED UNITED STATES PATENTS

U.S. Pat. No. 6,354,449

U.S. Pat. No. 6,112,919

U.S. Pat. No. 6,089,389

U.S. Pat. No. 5,419,445

U.S. Pat. No. 5,312,282

U.S. Pat. No. 5,024,341

D414873

U.S. Pat. No. 1,672,467

U.S. Pat. No. 2,771,073

U.S. Pat. No. 2,882,947

U.S. Pat. No. 3,072,272

U.S. Pat. No. 3,323,669

U.S. Pat. No. 3,401,813

U.S. Pat. No. 3,586,196

U.S. Pat. No. 3,747,791

U.S. Pat. No. 3,888,373

U.S. Pat. No. 4,387,819

U.S. Pat. No. 4,711,365

U.S. Pat. No. 84,970

U.S. Pat. No. 322,837

U.S. Pat. No. 2,499,518

U.S. Pat. No. 2,583,387

U.S. Pat. No. 2,029,379

### FIELD OF THE INVENTION

The invention relates to a teat adapter for a bottle having an outer threaded neck.

### BACKGROUND OF THE INVENTION

Purified water, fruit juices and electrolyte replenishment drinks have been used for a long time for preparing drinks in feeding bottles for infants and toddlers, which generally comprise a nipple removably fixed to a bottle with a wide neck by means of a threaded ring adapted to be screwed on to said neck. The ring and the nipple after being fitted on the bottle form a liquid tight end-piece, which allows air to enter the feeding bottle, progressively as the infant sucks. The bottles and the threaded end-pieces are sterilized before the feeding bottles are filled, including those to be filled with purified water, fruit juices or electrolyte replenishment drinks which are frequently given to a young child during walks, journeys or similar outings, or when dehydrated or ill. It is then necessary, during such outings, to take one or more sterilized nipple bottles and the purified water, fruit juices or electrolyte replenishment drinks for filling them. The weight and space required, particularly for a young mother, may then be a hindrance.

Adapters heretofore designed for this purpose have had three drawbacks in their application: An adapter ring housing both outer and inner threads is difficult to remove from the end-piece; an adapter ring housing both inner and outer threads, when assembled as bottle and nipple, does not facilitate grasping by a infant's or toddler's small hands; separate sealing rings for the chimney may become displaced and render such adapters useless.

### OBJECT OF THE INVENTION

It is precisely an object of the invention to provide a device overcoming, these drawbacks.

### SUMMARY OF THE INVENTION

In this respect, an object of the invention is to take advantage of the fact that purified water, fruit juices and electrolyte replenishment drinks can now be found on the market packed, in the factory and with all guarantees of hygiene, in bottles comprising an outer threaded ring, even though these bottles comprise, during manufacture, necks having a threaded portion of given diameter, different from that of the threaded portions of the usual threaded end-pieces sold commercially. Consequently, an object of the invention is to provide an adapter for simply and reliably associating a usual threaded end-piece with bottle comprising a threaded neck, in particular a purified water, fruit juice or electrolyte replenishment drink bottle made from plastic material.

A threaded end-piece adapter according to the invention, for a bottle comprising an outer threaded neck is then characterized by the fact that it has an inner threaded chimney on one end adapted for cooperating with the threaded neck of the bottle, an external sidewall on the other end of the adapter also threaded for receiving the end-piece and, in addition, a skirt connected to the chimney, shaped and positioned so that it cooperates sealingly with the internal face of the ring of the bottle when the adapter is fixed thereon by screwing its chimney on said ring. The adapter is configured to act as an extension of the bottle neck, thereby creating a neck which an infant or toddler can easily grasp, and making it accessible for a caregiver to disassemble for cleaning.

In a preferred embodiment of the invention, the adapter is made from plastic material, such as polyethylene, advantageously molded in one place by injection so as to form at the inner end of the skirt a multiplicity of spokes, which are then sectioned (i.e. cut). The chimney is advantageously connected to the skirt by a flat annular portion. In a preferred embodiment, the diameter of the inner threaded chimney is about 0.75 to 1.5 inches and the diameter of the external threaded sidewall about 1.25 inches.

### BRIEF DESCRIPTION OF THE DRAWINGS

The invention will be well understood from the following description, given by way of example, with reference to the accompanying drawings in which:

FIG. 1 is an exploded view, half in section and half in elevation, of a bottle of purified water, fruit juice or electrolyte replenishment drink comprising an outer threaded neck with which is associated an adapter according to the invention and a threaded end-piece device.

FIG. 2 is a view, half in section, half in elevation, similar to that of FIG. 1, but showing the assembled elements;

FIG. 2A is a partial view, on a larger scale, of a portion of FIG. 2; and

FIG. 3 is a view half in section and half in elevation, on a larger scale, of an adapter according to the invention.

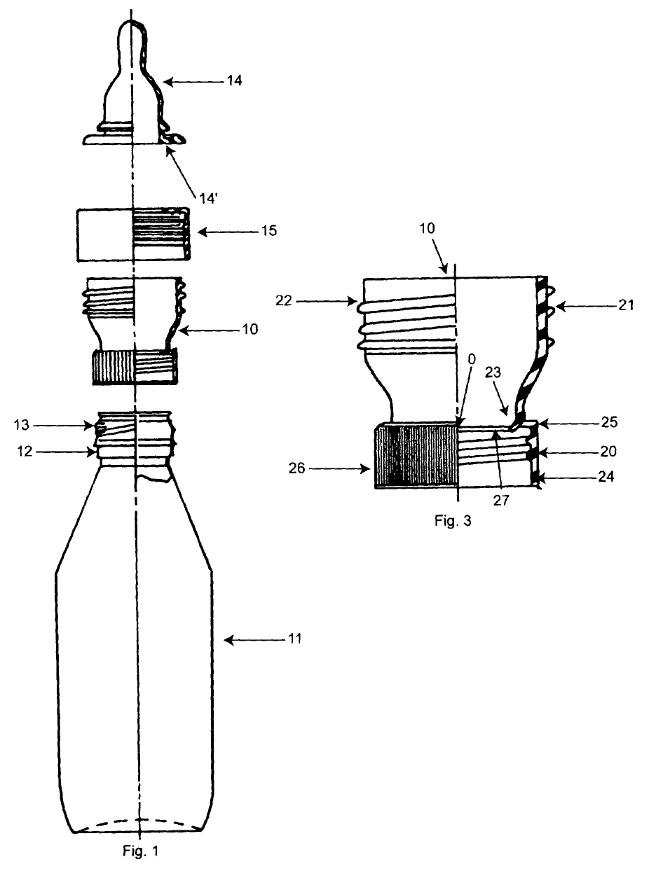

### DESCRIPTION OF THE PREFERRED EMBODIMENTS

A threaded end-piece adapter 10, according to the invention, is intended to equip a bottle 11 whose neck 12 comprises a thread 13. Bottle 11 may, without this indication having any limitative character, be a glass bottle or a plastic material bottle, advantageously made from PVC, containing from 8 to 16 ounces and which is filled with purified water, fruit juice or electrolyte replenishment drink in the bottling factory. For bottles of this type, neck 12 with which a screw cap, not shown, cooperates for sealing closing same, has a diameter which is about 0.75 to 1.5 inches so that it cannot directly receive a usual threaded nipple end-piece sold commercially. It is in order to permit fitting of such an end-piece, formed by a nipple 14 with collar 14′ and threaded ring 15, that the invention provides the adapter 10. As can be seen in FIG. 3, it has an inner chimney 20 adapter for cooperating with thread 13 of the neck of bottle 11, an external sidewall 21 with thread 22 for receiving ring 15 of the threaded end-piece and a substantially cylindrical skirt 23 of a smaller diameter than chimney 20 to which it is connected by a flat annular portion 24. The free end of the external sidewall 21 is formed, following a shoulder 25, as a short sleeve 24′, engine turned on its external face, as shown at 26, so as to facilitate actuation thereof.

In a preferred embodiment, an adapter 10 is molded in a single piece from plastic material, such as polyethylene and preferably by injection from center 0 of the circle defined by the free end 27 of skirt 23 so as to form first of all a multiplicity of spokes which are then sectioned from the adapter itself.

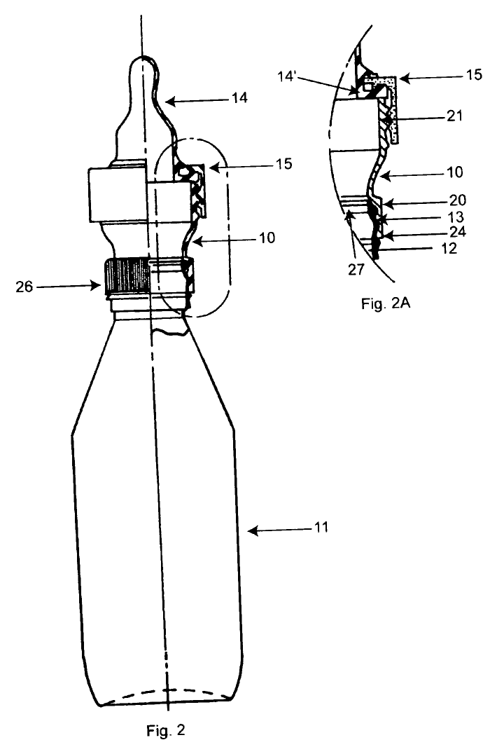

The method of using the latter is immediately clear from the foregoing. After removing the screw cap from bottle 11, the latter is fitted with adapter 10 by screwing chimney 20 which it comprises on thread 13, which simultaneously sealing applies skirt 23 against the internal face of neck 12 of the bottle, taking into consideration the dimensions and positioning of said skirt, FIG. 2A. When the nipple end-piece is then fitted to the adapter, by screwing ring 15 on the external sidewall 21 with screw thread 22, a feeding bottle of purified water, fruit juice or electrolyte replenishment drink is very simply obtained, ready to be given to an infant or toddler. The result is obtained by using the usual threaded end-pieces found in commerce, namely end-pieces whose ring 15 has a diameter of about 1.25 inches, and that simply and reliably, without it being necessary to apply an appreciable tightening torque for sealing the end-piece on the bottle, without having to use an added seal and without altering the operation of the nipple which, although water-tight, nevertheless allows air to enter the feeding bottle progressively as the infant sucks.

Adapter 10 may be used and re-used numerous times without having to take other precautions than that of keeping it clean.

What is claimed:

1. An adapter for adapting a nipple end-piece having an internally threaded ring onto a bottle having an outer threaded neck, said adapter comprising an outer threaded sidewall on one end for receiving said internally threaded ring of the end-piece, an internally threaded chimney on the other end of the adapter adapted for cooperating with said neck of the bottle, and a skirt within said chimney and connected to said chimney, shaped and positioned so that it cooperates sealingly with an internal face of the neck of the bottle when the adapter is fixed thereon by screwing its chimney onto said neck of the bottle.

2. The adapter as claimed in claim 1 wherein said chimney is connected to said skirt by a substantially flat annular portion.

3. The adapter as claimed in claim 1 wherein the diameter of said inner threaded chimney is about 0.75 to 1.5 inches and the diameter of the external threaded sidewall about 1.25 inches.

4. The adapter as claimed in claim 1 wherein the adapter is configured to act as an extension of the bottle neck, thereby creating a neck which an infant or toddler can easily grasp.

5. The adapter as claimed in claim 1 wherein the adapter is configured to act as an extension of the bottle neck, making it accessible for a caregiver to disassemble for cleaning.
